(19) United States
(12) Patent Application Publication
(10) Pub. No.: US 2013/0112324 A1
(43) Pub. Date: May 9, 2013

(54) VEHICLE TYRE COMPRISING A RADIOFREQUENCY TRANSPONDER

(71) Applicant: Claudio Battocchio, Clermont-Ferrand (FR)

(72) Inventor: Claudio Battocchio, Clermont-Ferrand (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/807,330

(22) PCT Filed: Jul. 5, 2011
(86) PCT No.: PCT/FR11/51591

§ 371 Date: Jan. 23, 2013

(30) Foreign Application Priority Data
Jul. 8, 2010 (FR) 1055581

(51) Int. Cl. B60C 19/00

(52) U.S. Cl. CPC B60C 19/00
USPC 152/151; 156/60

(57) ABSTRACT

A vehicle tyre is described, which includes a rubber mass and a radiofrequency transponder. The rubber mass has a joining zone in a circumferential direction on an inner face of the tyre. The radiofrequency transponder forms an angle (θ) with the joining zone about a main axis of the tyre, with the angle (θ) being greater than or equal to 90°.

The invention relates to tyres for vehicle wheels.

It is known practice, for example from document EP-1 977 912, to place in a tyre of a vehicle wheel a radio frequency identification transponder, also called a radio label or RFID (for radio frequency identification) label. The transponder is placed in one of the two lateral sidewalls of the tyre. It is possible to record therein information, notably relating to the manufacture of the tyre, that may then be read remotely at various stages of use and of the life of the tyre by means of an appropriate reader. It is therefore important to be able to read with ease and in all circumstances the information included in the transponder. However, it is found that this reading operation is sometimes difficult to achieve, the reader having to be placed very close to the tyre for the communication to take place. It involves a difficulty notably when the tyre forms part of a wheel that is already fitted on a vehicle.

One object of the invention is to make easier the interaction with a transponder of a tyre of a vehicle wheel.

Accordingly, according to the invention, a vehicle tyre is proposed which comprises:
a rubber mass having a joining zone in the circumferential direction on an inner face of the tyre, and
a radiofrequency transponder forming an angle that is greater than or equal to 90° with the joining zone about a main axis of the tyre.

Specifically, the inventors have examined whether a correlation existed between the position of the transponder located relative to a singular point of the tyre and the quality of communication with the transponder. They were then surprised to find that such a correlation effectively existed if the position of the transponder was located relative to the joining zone of the rubber to itself in the circumferential direction on the inner face of the tyre. This zone where the rubber is welded to itself is easy to locate by sight and by touch on most tyres. It is even conventionally taken into account during the positioning of various layers of rubber and of other components of the tyre when the latter is produced, in particular during the construction of the preform. It is found that remote communication with the transponder is much better when the aforementioned angle is greater than or equal to 90° than when it is less than this value. In particular, it is found that reading can then take place at a greater distance from the tyre. This unexpected result makes it possible to position the transponders within the tyres while improving the level of assurance of the quality of communications with the transponder.

Preferably, the angle is greater than or equal to 135°, notably greater than 150°, and preferably equal to 180°.

This latter value corresponds specifically to the position of the transponder that allows communication at the greatest distance.

Preferably, the transponder is in contact with a sidewall of the tyre supporting inscriptions giving information on the tyre.

Specifically, it has also been observed that the tyre could be read at a greater distance if the transponder was supported by the sidewall supporting the DOT (Department of Transportation: the regulatory marking relating amongst other things to the plant and date of the manufacture of the tyre) than if it were supported by the other sidewall.

Also according to the invention, provision is made for a set of several tyres in which the two tyres or at least two of the tyres, preferably all the tyres, conform to the invention.

Provision is also made according to the invention for a vehicle that comprises at least two tyres according to the invention, preferably all the tyres of the vehicle conforming to the invention.

Also provided according to the invention is a raw vehicle tyre preform that comprises:
a rubber mass having a joining zone in the circumferential direction on an inner face of the preform, and
a radiofrequency transponder forming an angle greater than or equal to 90° with the joining zone about a main axis of the preform.

Also provided according to the invention is a set of several raw tyre preforms in which the two preforms or at least two of the preforms, preferably all the preforms, conform to the invention.

Also provided according to the invention is a method for manufacturing a raw vehicle tyre preform or a vehicle tyre, in which a radiofrequency transponder (12) is placed on a rubber mass so that the transponder forms an angle greater than or equal to 90° with a joining zone (16) of the rubber in the circumferential direction on an inner face of the preform or of the tyre about a main axis of the perform or of the tyre.

Specifically, provision can be made for the transponder to occupy the aforementioned position when the transponder is placed in the preform used to manufacture the tyre.

Advantageously several preforms or several tyres are produced consecutively according to the invention.

Also provided according to the invention is a method for treating at least one vehicle tyre, in which a radiofrequency transponder is attached to a cured rubber mass so that the transponder forms an angle greater than or equal to 90° with a joining zone of the rubber in the circumferential direction on an inner face of the tyre about a main axis of the tyre.

Therefore, it is also possible to provide for the transponder to be fitted to a tyre that is already manufactured. It may be even be a tyre that has already been used, that is to say that has already run with a vehicle. Even in this case, it is possible to improve the quality of remote communication with the transponder by placing the latter in an appropriate manner on the tyre.

Advantageously, several tyres are treated consecutively according to the invention.

Other features and advantages of the invention will also appear in the following description of an embodiment given as a non-limiting example with reference to the appended drawings in which:

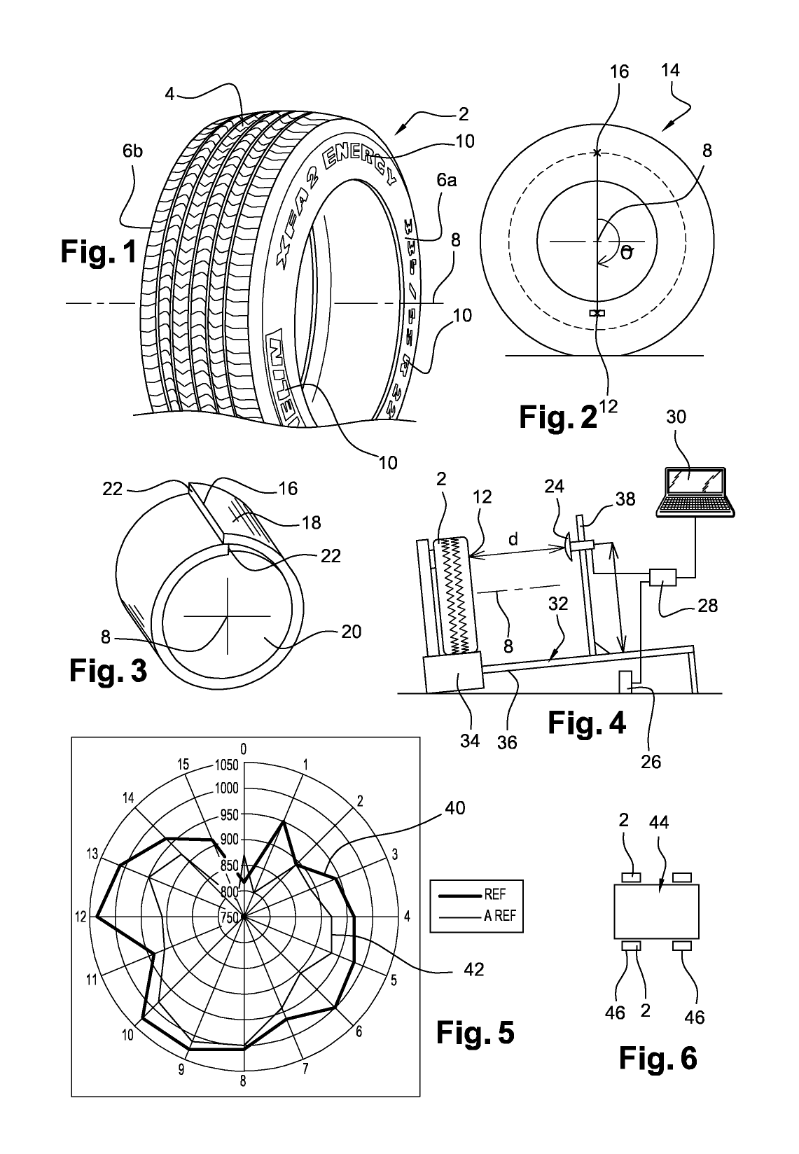

FIG. 1 is a partial view in perspective of a tyre according to the invention;

FIG. 2 is a view in elevation of the preform that has been used to manufacture the tyre of FIG. 1;

FIG. 3 is a view in perspective illustrating a step of producing the preform of FIG. 2;

FIG. 4 is a view in elevation showing an installation for taking experimental measurements;

FIG. 5 is a diagram illustrating the result of these measurements; and

FIG. 6 is a schematic view of a vehicle fitted with tyres according to the invention.

Illustrated in FIG. 1 is a tyre 2 according to the invention for a vehicle wheel. The vehicle may be a passenger vehicle, a utility vehicle, a heavy goods vehicle or a construction machine and may comprise two, three, four or more wheels.

The tyre 2 notably has a crown zone 4 designed to be in contact with the road and two sidewalls 6a and 6b forming side zones. The tyre comprises a main axis 8. The crown zone has an outer face having a generally cylindrical shape relative to the axis 8 while the sidewalls 6a and 6b have an annular shape that is generally flat and perpendicular to this axis.

The tyre comprises rubber formed of a blend of various components, notably natural rubber, synthetic rubber and chemical additives (sulphur, carbon black, oil, etc). It also comprises textile and/or metal cords.

The sidewall 6a that can be seen in FIG. 1 is in this instance the reference side and comprises the DOT, while the sidewall 6b is the anti-reference side. They will be called respectively the “REF side” and “AREF side”. The AREF side 6b supports a reference number containing a unique serial number that is used to recognize the tyre. The two sides comprise various markings 10 that are formed in relief and/or are recessed in the rubber and that may contain for example all or some of the following information:
a brand name associated with the tyre;
the type of tyre;
a sidewall width in millimetres;
the indication “tubeless” (TL) indicating that the tyre has no inner tube;
the load index;
the speed index;
the shape factor;
the letter “R” indicating that the tyre has a radial structure;
the name of the manufacturer; and
the seat diameter of the tyre.

The tyre 2 comprises a radio frequency identification transponder or label 12. This transponder was incorporated into the tyre when the preform 14 illustrated in FIG. 2 was manufactured and, for example, as described in document EP-1 977 912 to which reference should be made for further explanation.

The transponder 12 is of a type known per se and consists of a semiconductor chip and an antenna. A reader is capable of reading and writing data in the chip. Communication and power supply of the transponder are carried out by radiofrequency. For this, a reader specifically adapted for this purpose sends a request to the transponder that is in the field of the reader and the transponder replies to it immediately, all this taking place according to a predetermined communication protocol. The electronic chip is furnished with a memory in which the reader can, depending on the case, read or write data. For this, the reader emits radiowaves and then listens for the response(s) supplied by the transponder which is in its reading field. The transponder 12 is in this instance intended for communication by radiowaves but it is possible to provide for it to be capable of communication by electromagnetic field. The transponder is for example designed to communicate at frequencies of 869 MHz and/or 915 MHz. It has linear polarization in this instance.

It is in this instance a passive transponder, therefore having no autonomous means of power supply with electric current. The transponder is powered only when it receives electromagnetic waves from a reader, these waves inducing a current in the antenna of the transponder in order to supply it with power. The collection of power therefore takes place through the antenna of the transponder consisting of a dipole which provides an induced AC voltage at its terminals, a voltage that must be rectified, filtered and regulated in order to power the rest of the integrated circuit of the transponder.

In this instance, it is a multiple read and write transponder. It is installed blank into the preform 14 of the tyre 2 and then can receive write data several times, modify these data, delete these data, add data and be read.

Nevertheless, it would be possible to provide a transponder of another type, for example a transponder with which it is possible to write once and read several times. In this case, the transponder is delivered blank and then subjected to a single write phase by the tyre manufacturer. Once this write phase is complete, the transponder falls into read-only mode and the writing of data is no longer possible. All that is possible is the reading of the data recorded in the transponder.

The transponder may comprise for example all or some of the following data:
the manufacturer code, item code and serial number of the tyre;
the position of the tyre on the vehicle;
the vehicle mileage that was recorded at the time of the last inspection, etc.

The transponder 12 is inserted in the sidewall 6a and preferably rather than in the sidewall 6b. The quality of communication with the transponder is in fact better when it is supported by the REF side. This difference in behaviour between the two sidewalls results from the method of curing the preform of the tyre. Specifically, the sidewall 6a is first to come into contact with the bottom face of the press used to mould and secure the tyre when the preform is placed in the mould. This bottom face is the hottest. The sidewall 6a therefore begins curing before the mould is closed and sooner than the other sidewall 6b. The same dissymmetry occurs when opening the mould since sidewall 6b is placed in contact with the ambient air when the mould is opened while the sidewall 6a is still in contact with the press.

Furthermore, seen on the preform and the tyre is the singular zone 16 formed by the zone of welding of the inner rubber 18 to itself in the circumferential direction with reference to the axis 8. Illustrated schematically in FIG. 3 is the placing of the inner rubber layer of the preform on a forming drum 20. This layer is designed to provide a seal for the air of the chamber defined by the inner face of the tyre. In this instance it has two rectilinear edges perpendicular to its longitudinal direction when it is laid out flat. The layer 18 is placed on the drum when superposing its two edges 22 one on the other in the direction radial to the axis 8. This forms a zone of overlap and of joining in the circumferential direction. This produces a slight extra thickness in this joining zone, ensuring a good seal and having the general shape of a line or a cord. This line or this cord appears on the inner face of the raw preform or on that of the tyre, including on the inner face of the sidewalls 6a and 6b.

Looking at the tyre or the preform with the sidewall 6a facing the observer as in FIG. 2, the angle θ is the angle formed about the axis 8 on the one hand by the half-line starting from this axis and passing through the joining zone 16 on the sidewall, and the half-line starting from the same axis and passing through the position of the transponder 12. In this instance angle values are considered to be in absolute value and not algebraic. In other words, the angle θ is measured in the clockwise direction or in the anticlockwise direction without distinction.

The transponder is installed so that the angle θ is greater than 90° and even than 135°, than 150° and than 170°. In this instance it is placed so that the angle θ is 180° such that the transponder 12 is diametrically opposite the weld 16 relative to the axis 8 when the sidewall 6a is looked at face on. This ensures a good quality of remote radio communication with the transponder for the writing and reading of data.

FIG. 4 shows a portion of an installation used to highlight the correlation between the value of the angle θ and the quality of remote communication with the transponder. In this instance, a transponder reader 28 marketed by the Siemens company under reference Simatic RF660R and an antenna marketed by the Intermec company, operating in the 865-928 MHz frequency band and having a nominal impedance of 50 Ohms, a gain of 6 dBi and linear polarization, are used. The antenna is used as an emitting antenna. Furthermore, for reception, an antenna marketed by the Siemens company under reference Simatic RF660A is used, operating in the 865-928 MHz frequency band, having a nominal impedance of 50 Ohms and a gain of 5 to 7 dBi with a circular polarization and an emit/receive angle of between 55° and 60°. The two antennas 24 and 26 are connected via two separate links to the reader 28 which is itself linked to a computer 30 ensuring data acquisition via an Ethernet link.

A measurement bench 32 is used that comprises a support 34 for the tyre 2, a metal rail 36 extending parallel with the axis 8 and at a distance from the latter, and a mast 38 perpendicular to the axis 8 and to the rail 36 and slidingly mounted at its base on the rail by appropriate means.

In this instance, several transponders 12 have been installed in one and the same tyre 2. The transponders are in this instance sixteen in number. They are all situated at the same distance from the axis 8 in the sidewall 6a and are evenly spaced about the axis. One of them is situated between the axis 8 and the zone 16. Another is diametrically opposed to the zone 16.

The tyre is placed so that the transponder 12 in question extends in a top position, that is to say vertical to the axis 8 and above the latter. The antenna 24 is placed at the same height as the transponder, the rail 36 serving as a height reference. During the experiment, a telemeter is used to measure the distance d separating the antenna 24 and the outer face of the sidewall 6a in line with the transponder.

The other antenna 26 is for its part positioned on the ground on a piece of foam and aimed towards the tyre. It is situated at a distance of at least 35 centimetres from the tyre, which distance is approximately the wavelength of the transmitted signal. The whole experiment is carried out in an anechoic chamber, namely a room of which the sidewalls absorb the sound or electromagnetic waves.

The following measurement protocol is used:
the centre of the emitting antenna 24 is placed at the height of the transponder in question;
the emitting antenna is placed against the sidewall 6a while bringing the mast 38 close to the tyre by sliding on the rail 36 and the telemeter that is used to measure the distance d is set to zero;
it is observed that the signal from the transponder in question is received at the reader 38 and the identity of the transponder is verified from the computer 30;
the antenna 24 is gradually moved away at moderate speed by sliding the mast 38 on the rail 36 until the signal is lost;
the antenna is again moved towards the tyre until the signal is again found and in this way, by trial and error, the maximum distance d is found that allows the transponder to be read by the reader 28;
the antenna is then immobilized and the distance obtained is read off with the aid of the telemeter.

Shown in the diagram of FIG. 6 are the distances thus obtained for each of the sixteen transponders of the REF sidewall 6a of the tyre. The values are connected by the curve 40. A similar experiment was carried out by placing sixteen other transponders in the other sidewall 6b, which resulted in the curve 42. In order to better observe the reading differences, the centre of the diagram corresponds to the distance of 750 millimetres, the distances indicated in the radial direction increasing in steps of 50 millimetres up to 1050 millimetres.

On the curve 40, for 1 W of power, the shortest distance is 820 millimetres and corresponds to the situation in which the transponder is situated in the alignment of the axis 8 and of the weld line 16, between the latter. It is therefore in this position of the transponder, the closest to the zone 16, that reading is hardest. In other words, it is therefore necessary to be particularly close to the transponder to carry out a correct reading of the data that it contains. Conversely, good reading results are obtained when the transponder is positioned such that the angle θ is greater than 90°. Thus, in the transponder position illustrated in FIG. 2, a distance d of 1 metre is obtained.

The curve 42 corresponding to the AREF sidewall 6b has a general appearance close to that of the curve 40. However, the distances obtained are generally shorter than those of the curve 40, such that it is preferable to position the transponder on the sidewall 6a.

The diagram of FIG. 5 results from the measurements taken on a tyre furnished with sixteen transponders 12 on the sidewall 6a and sixteen transponders 12 on the sidewall 6b. Repeating the experiment on numerous similar tyres leads to a smoothing of the curve forming the average of the curves, which shows that the best positioning corresponds to the bottom of the curve and hence to values of θ that are close to 180°. The average curve has the general appearance of a cardioid, the re-entrant portion and the singular point of the cardioid corresponding to the transponder position closest to the weld zone. In other words, it is safest to place the transponder on the sidewall 6a situating it as far as possible from the weld zone 16.

In the embodiment described above, a single transponder 12 is placed in the preform 14 of the tyre comprising rubber that is raw, therefore before the curing of this preform in order to cure the rubber. The transponder is placed in the thickness of the sidewall or on an inner or outer face of the latter. It is possible to implement the transponder in the form of a component comprising at least two thin thicknesses of insulating raw rubber between which the transponder is interposed and enclosed. The rubber of the component is attached to the raw rubber of the preform between two layers of the latter, and then secured to the latter when the preform is cured.

It is nevertheless possible to apply the invention by fitting a single transponder 12 to a tyre 2 that is already cured, or even already used. This may be for example a tyre that has been fitted to a vehicle wheel and that has already run. The transponder 12 can therefore be placed on a tyre independently of the manufacture of the latter. It can be done in particular on receipt of a tyre that is already used. It is possible for example to attach the transponder to the inner wall of the sidewall 6a, or even to its outer wall. It is possible to install it in the zone designated by the term “brandbox”. It is possible, in this context, to sandwich the transponder 12 between two self-curing raw connecting rubbers.

It is possible to manufacture successively and consecutively several tyres 2, for example five, ten, one hundred or more in number, in the manner that has just been described. All the tyres of this series therefore have a transponder 12 positioned with an angle θ equal to 180° or near to this value.

This series makes it possible to produce a population of tyres that all comprise a transponder positioned in this manner. It is possible to find such a population in the stocks of a tyre manufacturer, or of a wholesaler or retailer, or else in the stocks of a vehicle manufacturer. It is also possible to find it within a fleet of an operator using a set of vehicles such as the vehicle 44 illustrated in FIG. 6. In such a population, the ratio of tyres according to the invention is not necessarily 100% but is preferably more than 50%, or even than 75% or 80%.

Similarly, within one vehicle 44, provision is made for all or some of the vehicle tyres 2 to conform to the invention. This may involve all the tyres of the vehicle or else a majority of them, typically at least half of them. Similarly, provision is made according to the invention that, on a vehicle comprising one or more axles 46, this axle or at least one of the axles supports tyres that all conform to the invention, even though this is not the case of another axle of the vehicle if there is one. The vehicle of FIG. 6 comprises four wheels distributed on two axles. But the invention can also be used for vehicles with two, three, four wheels or more and on vehicles with more than two axles.

Note here that, exception being made of the positioning of the transponder with respect to the angle θ, the invention does not involve any change in the manufacture of the tyre or in the general qualities and performance of the latter.

It is possible to position the transponder such that it is situated in the sidewall at a distance of approximately 15 millimetres from the central cord of the tyre, measured in the direction radial to the axis 8, and this is so notably when the transponder is housed in the location called the brandbox. If the transponder is on the side of the inner face of the sidewall 6a, it is possible to position it at a distance of approximately 80 millimetres from the ridge of the tyre sidewall measured in the radial direction.

Naturally, many modifications can be made to the invention without departing from the context of the latter.

It will be possible to apply the invention by installing the transponder 12 on the sidewall 6b corresponding to the AREF side.

The tyre according to the invention may have at least two transponders placed respectively on the sidewalls 6a and 6b, each with an angle θ greater than 90°. This embodiment is worthwhile when the tyre can be fitted to the vehicle with no consideration for a fitment direction, that is to say that the sidewall 6a need not be oriented preferably towards the inside or the outside of the vehicle. Irrespective of the fitment direction, it is therefore possible to read the transponder that is on the sidewall that is most visible and most accessible, and to do so with good transmission quality.

1-11. (canceled)

12. A vehicle tyre having an inner face and a main axis, the tyre comprising:
a rubber mass having a joining zone in a circumferential direction on the inner face of the tyre; and
a radiofrequency transponder positioned to form an angle (θ) with the joining zone about the main axis of the tyre, with the angle (θ) being greater than or equal to 90°.

13. The vehicle tyre according to claim 12, wherein the angle (θ) is greater than or equal to 135°.

14. The vehicle tyre according to claim 12, wherein the angle (θ) is greater than 150°.

15. The vehicle tyre according to claim 12, wherein the angle (θ) is equal to 180°.

16. The vehicle tyre according to claim 12, wherein the radiofrequency transponder is in contact with a sidewall of the tyre supporting a DOT code and inscriptions giving information on the tyre.

17. The vehicle tyre according to claim 12, wherein the tyre is part of a set of several tyres, and wherein the tyre and another tyre of the set conform to claim 12.

18. A vehicle comprising at least two tyres,
wherein each tyre of the at least two tyres has an inner face and a main axis, and
wherein each tyre of the at least two tyres includes:
a rubber mass having a joining zone in a circumferential direction on the inner face of the tyre, and
a radiofrequency transponder positioned to form an angle (θ) with the joining zone about the main axis of the tyre, with the angle (θ) being greater than or equal to 90°.

19. A raw vehicle-tyre preform having an inner face and a main axis, the preform comprising:
a rubber mass having a joining zone in a circumferential direction on the inner face of the preform, and
a radiofrequency transponder positioned to form an angle (θ) with the joining zone about the main axis of the preform, with the angle (θ) being greater than or equal to 90°.

20. The raw vehicle-tyre preform according to claim 19, wherein the preform is part of a set of several preforms, and wherein the preform and another preform of the set conform to claim 19.

21. A method for manufacturing a raw vehicle-tyre preform having an inner face and a main axis, the method comprising:
placing a radiofrequency transponder on a rubber mass having a joining zone in a circumferential direction on the inner face of the preform, the transponder being positioned to form an angle (θ) with the joining zone about the main axis of the preform, with the angle (θ) being greater than or equal to 90°.

22. The method according to claim 21, wherein the method is performed consecutively on several raw vehicle-tyre preforms.

23. A method for manufacturing a vehicle tyre having an inner face and a main axis, the method comprising:
placing a radiofrequency transponder on a rubber mass having a joining zone in a circumferential direction on the inner face of the tyre, the transponder being positioned to form an angle (θ) with the joining zone about the main axis of the tyre, with the angle (θ) being greater than or equal to 90°.

24. The method according to claim 23, wherein the method is performed consecutively on several vehicle tyres.
